(19) United States
(12) Patent Application Publication
(10) Pub. No.: US 2004/0032370 A1
(43) Pub. Date: Feb. 19, 2004

(54) Portable radio-use antenna

(76) Inventors: Hideo Ito, Tokyo (JP); Kiyoshi Egawa, Kanagawa (JP); Yasunori Komukai, Miyagi (JP)

Correspondence Address: STEVENS DAVIS MILLER & MOSHER, LLP, 1615 L STREET, NW, SUITE 850, WASHINGTON, DC, 20036, US

(21) Appl. No.: 10/381,105

(22) PCT Filed: Jul. 23, 2002
(86) PCT No.: PCT/JP02/07409

(30) Foreign Application Priority Data
Jul. 25, 2001 (JP) 2001-225197

(51) Int. Cl. H01Q 1/24

(52) U.S. Cl. 343/702; 343/700 MS

(57) ABSTRACT

An antenna for a cellular wireless apparatus which has the directivity in the direction opposite to the human body and improves the antenna gain. Wireless-apparatus base 10 is a circuit board and feeds power to planar radiation element 20. Planar radiation element 20 is disposed on an upper surface of wireless-apparatus base 10, given power, and transmits and receives radio signals. Parasitic element 30 is on its one end short-circuited with wireless-apparatus base 10, and disposed so that the center axis thereof is parallel to the center axis of planar radiation element 20. A length of parasitic element 30 is set to operate as a reflector.

### TECHNICAL FIELD

The present invention relates to an antenna for a cellular wireless apparatus used in the cellular wireless apparatus such as a cellular telephone.

### BACKGROUND ART

Conventionally, as an antenna for a cellular wireless apparatus, a monopole antenna as shown in FIG. 1 is generally used. The antenna has a configuration where radiation element 130 is disposed on a side of wireless-apparatus base 10. In the antenna with such a configuration where, for example, the size of wireless-apparatus base 10 is 42 mm×124 mm and the length of radiation element 130 is 20 mm, when radio signals of 902 MHz are transmitted, the directivity on the plane vertical to radiation element 130 is almost omnidirectional as shown in FIG. 2.

However, when the cellular wireless apparatus with the antenna is carried and used, radio waves are radiated from the antenna in omnidirectionality, and therefore, are affected by the body of a user using the cellular wireless apparatus, and the antenna gain thereby decreases.

### DISCLOSURE OF INVENTION

It is an object of the present invention to provide the directivity in the direction opposite to a human body and thus improve the antenna gain.

It is a subject matter of the present invention that a parasitic element is disposed adjacent to a radiation element on a wireless-apparatus base of an antenna so as to operate the parasitic element as a director or reflector, and thus the directivity is provided in the direction opposite to the body of a user.

According to one embodiment of the present invention, an antenna for a cellular wireless apparatus has a configuration with a base of the wireless apparatus, a radiation element to which power is fed from the base, and a parasitic element which is disposed adjacent to the radiation element and has an electrical length for operating as a reflector or director.

According to another embodiment of the present invention, an antenna for a cellular wireless apparatus has a configuration where the radiation element is comprised of a plurality of radiation element members coupled in series via an inductive element that is disposed between adjacent radiation element members, and in transmitting and receiving radio signals of frequency at which a radiation element member on a power-feeder side of the inductive element resonates, the radiation element members that sandwich the inductive element are electrically interrupted.

### BRIEF DESCRIPTION OF DRAWINGS

FIG. 1 is a view illustrating a configuration of a conventional antenna for a cellular wireless apparatus;

FIG. 2 is a view showing the directivity of the conventional antenna for a cellular wireless apparatus;

FIG. 3A is a schematic perspective view illustrating a configuration of an antenna for a cellular wireless apparatus according to first and second embodiments of the present invention;

FIG. 3B is a side view illustrating the configuration of the antenna for a cellular wireless apparatus according to the first and second embodiments;

FIG. 4 is a view showing the directivity of the antenna for a cellular wireless apparatus according to the first embodiment;

FIG. 5 is a view showing the directivity of the antenna for a cellular wireless apparatus according to the second embodiment;

FIG. 6A is a schematic perspective view illustrating a configuration of an antenna for a cellular wireless apparatus according to third and fourth embodiments of the present invention;

FIG. 6B is a side view illustrating the configuration of the antenna for a cellular wireless apparatus according to the third and fourth embodiments;

FIG. 7 is a view illustrating a configuration of an antenna for a cellular wireless apparatus according to a fifth embodiment of the present invention;

FIG. 8 is a view illustrating another configuration of an antenna for a cellular wireless apparatus according to the fifth embodiment;

FIG. 9 is a view illustrating a configuration of an antenna for a cellular wireless apparatus according to a sixth embodiment of the present invention;

FIG. 10 is a view illustrating another configuration of an antenna for a cellular wireless apparatus according to the sixth embodiment;

FIG. 11 is a view illustrating another configuration of an antenna for a cellular wireless apparatus according to the sixth embodiment;

FIG. 12 is a view illustrating another configuration of an antenna for a cellular wireless apparatus according to the sixth embodiment;

FIG. 13 is a view illustrating a configuration of an antenna for a cellular wireless apparatus according to a seventh embodiment of the present invention;

FIG. 14 is a view illustrating a configuration of an antenna for a cellular wireless apparatus according to an eighth embodiment of the present invention;

FIG. 15 is a view illustrating another configuration of an antenna for a cellular wireless apparatus according to the eighth embodiment;

FIG. 16 is a view illustrating a configuration of an antenna for a cellular wireless apparatus according to a ninth embodiment of the present invention;

FIG. 17 is a view illustrating another configuration of an antenna for a cellular wireless apparatus according to the ninth embodiment;

FIG. 18 is a view illustrating a configuration of an antenna for a cellular wireless apparatus according to a tenth embodiment of the present invention;

FIG. 19 is a view illustrating another configuration of an antenna for a cellular wireless apparatus according to the tenth embodiment;

FIG. 20A is a schematic perspective view illustrating a configuration of an antenna for a cellular wireless apparatus according to an eleventh embodiment of the present invention;

FIG. 20B is a side view illustrating the configuration of the antenna for a cellular wireless apparatus according to the eleventh embodiment;

FIG. 21A is a schematic perspective view illustrating another configuration of an antenna for a cellular wireless apparatus according to the eleventh embodiment;

FIG. 21B is a side view illustrating the another configuration of the antenna for a cellular wireless apparatus according to the eleventh embodiment;

FIG. 22 is a view illustrating another configuration of an antenna for a cellular wireless apparatus according to the eleventh embodiment;

FIG. 23 is a view illustrating a shape of a radiation element and a parasitic element of an antenna for a cellular wireless apparatus according to the eleventh embodiment; and

FIG. 24 is a view illustrating a shape of an inductor loaded on a radiation element and a parasitic element of an antenna for a cellular wireless apparatus according to the eleventh embodiment.

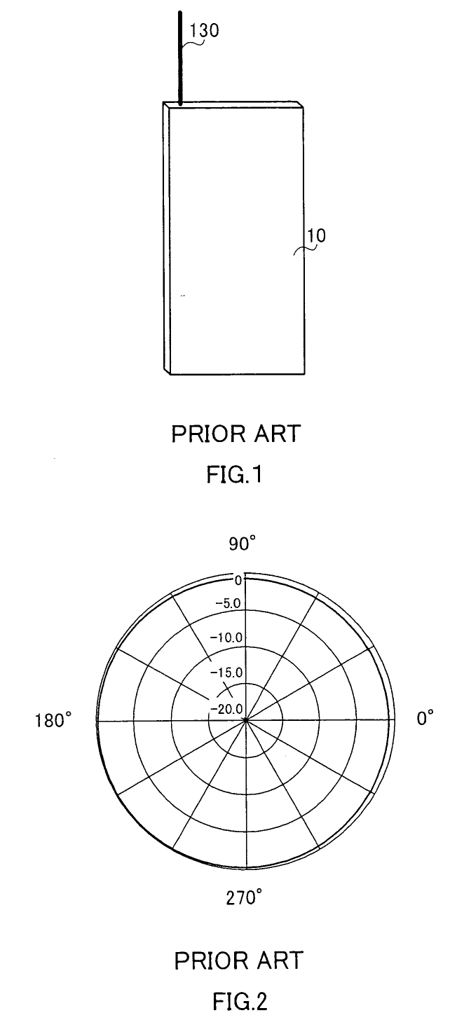

### BEST MODE FOR CARRYING OUT THE INVENTION

Embodiments of the present invention will be described below with reference to accompanying drawings.

(First Embodiment)

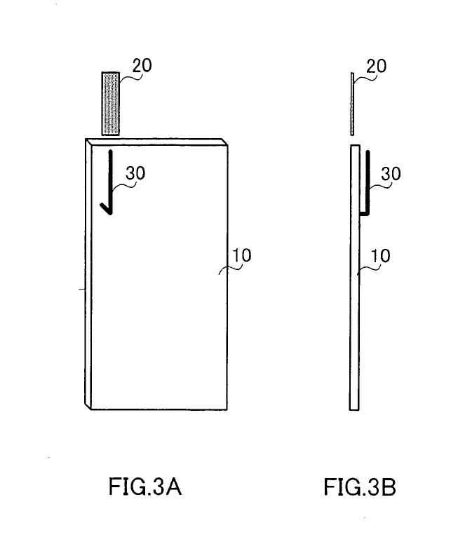

FIGS. 3A and 3B are views illustrating a configuration of an antenna for a cellular wireless apparatus according to the first embodiment of the present invention. In addition, FIG. 3A is a schematic perspective view viewed from the body of a user using the cellular wireless apparatus with the antenna for the cellular wireless apparatus according to the first embodiment. In the side view as shown in FIG. 3B, the body of the user exists to the right of the cellular wireless apparatus.

The antenna for a cellular wireless apparatus shown in these figures is comprised of wireless-apparatus base 10, planar radiation element 20 and parasitic element 30.

Wireless-apparatus base 10 is a circuit board and feeds power to planar radiation element 20. Planar radiation element 20 is disposed on an upper surface of wireless-apparatus base 10, is given power and receives and transmits radio signals. Parasitic element 30 is on its one end short-circuited with wireless-apparatus base 10, and is disposed so that the center axis thereof is parallel to the center axis of planar radiation element 20. Further, the length of parasitic element 30 is set to operate as a reflector.

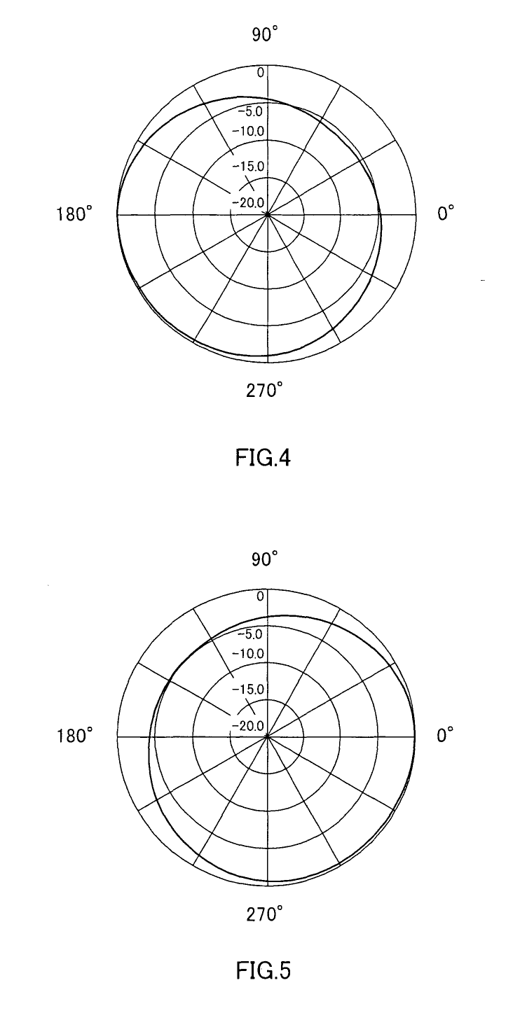

FIG. 4 is a view showing a result obtained by measuring the directivity of radio signals transmitted and received in the antenna for a cellular wireless apparatus according to the first embodiment of the present invention. In addition, the measurements were performed under conditions that the size of wireless-apparatus base 10 is 42 mm×124 mm, parasitic element 30 with a length of 82 mm is spaced 3.5 mm apart from wireless-apparatus base 10, and that radio signals of 902 MHz are used. Parasitic element 30 has the length for operating as a reflector.

In FIG. 4, 0° is in the direction of the side of wireless-apparatus base 10 on which parasitic element 30 is present (in this embodiment, human-body side), and on the contrary, 180° is in the direction of the other side of wireless-apparatus base 10 on which parasitic element 30 is not present (in this embodiment, opposite side to the human body). It is understood from the figure that the directivity of the antenna for a cellular wireless apparatus according to this embodiment has low level at 0° (human-body side) while having high level at 180° (opposite side to the human body).

As described above, in the antenna for a cellular wireless apparatus according to this embodiment, a parasitic element with a length for operating as a reflector is disposed on the side toward the body of a user of the cellular wireless apparatus. Therefore, the antenna has the directivity in the direction opposite to the human body, and it is thus possible to reduce effects caused by the human body and improve the antenna gain.

(Second Embodiment)

It is a feature of the second embodiment to provide a parasitic element disposed on the wireless-apparatus base with a length for operating as a director and dispose the parasitic element on the opposite side to the body of a user of the cellular wireless apparatus. A configuration of the antenna for a cellular wireless apparatus according to the second embodiment is almost the same as that in the first embodiment, and is as shown in FIGS. 3A and 3B. In addition, in the second embodiment, FIG. 3A is a schematic perspective view viewed from the direction opposite to the body of a user using the cellular wireless apparatus with the antenna for the cellular wireless apparatus according to the second embodiment. In the side view as shown in FIG. 3B, the body of the user exists to the left of the cellular wireless apparatus.

In FIGS. 3A and 3B, parasitic element 30 is on its one end short-circuited with wireless-apparatus base 10, and is set for a length to operate as a director.

FIG. 5 is a view showing a result obtained by measuring the directivity of radio signals transmitted and received in the antenna for a cellular wireless apparatus according to the second embodiment of the present invention. In addition, the measurements were performed under conditions that the size of wireless-apparatus base 10 is 42 mm×124 mm, parasitic element 30 with a length of 81 mm is spaced 3.5 mm apart from wireless-apparatus base 10, and that radio signals of 902 MHz are used. Parasitic element 30 has the length for operating as a director.

In FIG. 5, 0° is in the direction of the side of wireless-apparatus base 10 on which parasitic element 30 is present (in this embodiment, opposite side to the human body), and on the contrary, 180° is in the direction of the other side of wireless-apparatus base 10 on which parasitic element 30 is not present (in this embodiment, human-body side). It is understood from the figure that the directivity of the antenna for a cellular wireless apparatus according to this embodiment has high level at 0° (opposite side to the human body), while having low level at 180° (human-body side).

As described above, in the antenna for a cellular wireless apparatus according to this embodiment, a parasitic element with a length for operating as a director is disposed on the opposite side to the body of a user of the cellular wireless apparatus. Therefore, the antenna has the directivity in the direction opposite to the human body, and it is thus possible to reduce effects caused by the human body and improve the antenna gain.

(Third Embodiment)

It is a feature of the third embodiment that opposite ends of a parasitic element are opened without being short-circuited with the wireless-apparatus base.

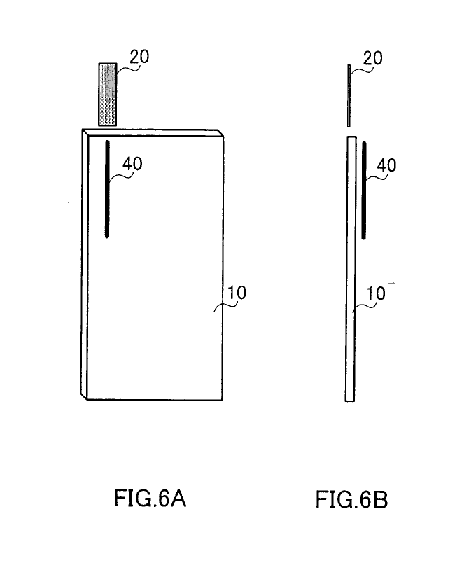

FIGS. 6A and 6B are views illustrating a configuration of an antenna for a cellular wireless apparatus according to the third embodiment. In addition, FIG. 6A is a schematic perspective view viewed from the body of a user using the cellular wireless apparatus with the antenna for the cellular wireless apparatus according to the third embodiment. In the side view as shown in FIG. 6B, the body of the user exists to the right of the cellular wireless apparatus. In addition, in FIGS. 6A and 6B the same members as in the antenna for a cellular wireless apparatus in FIGS. 3A and 3B are assigned the same reference numerals to omit descriptions thereof.

The antenna for a cellular wireless apparatus shown in these figures is comprised of wireless-apparatus base 10, planar radiation element 20 and parasitic element 40.

Parasitic element 40 is opened on its opposite ends and set for a length for operating as a reflector.

According to the above configuration, the directivity of the antenna for a cellular wireless apparatus is in the direction of from parasitic element 40 to planar radiation element 20 (opposite side to the human body).

As described above, in the antenna for a cellular wireless apparatus according to this embodiment, a parasitic element with a length for operating as a reflector is disposed on the side toward the body of a user of the cellular wireless apparatus. Therefore, the antenna has the directivity in the direction opposite to the human body, and it is thus possible to reduce effects caused by the human body and improve the antenna gain. Further, since opposite ends of the parasitic element are opened, it is possible to eliminate the need that the parasitic element is short-circuited with the wireless-apparatus base.

(Fourth Embodiment)

It is a feature of the fourth embodiment that a parasitic element is opened on its opposite ends without being short-circuited with the wireless-apparatus base, set for a length for operating as a director, and disposed on the opposite side to the body of a user of the cellular wireless apparatus. A configuration of the antenna for a cellular wireless apparatus according to the fourth embodiment is almost the same as that in the third embodiment, and is as shown in FIGS. 6A and 6B. In addition, in the fourth embodiment, FIG. 6A is a schematic perspective view viewed from the direction opposite to the body of a user using the cellular wireless apparatus with the antenna for the cellular wireless apparatus according to the fourth embodiment. In the side view as shown in FIG. 6B, the body of the user exists to the left of the cellular wireless apparatus.

In FIGS. 6A and 6B, parasitic element 40 is opened on its opposite ends and set for a length for operating as a director.

According to the above configuration, the directivity of the antenna for a cellular wireless apparatus is in the direction of from planar radiation element 20 to parasitic element 40 (opposite side to the human body).

As described above, in the antenna for a cellular wireless apparatus according to this embodiment, a parasitic element with a length for operating as a director is disposed on the opposite side to the body of a user of the cellular wireless apparatus. Therefore, the antenna has the directivity in the direction opposite to the human body, and it is thus possible to reduce effects caused by the human body and improve the antenna gain. Further, since opposite ends of the parasitic element are opened, it is possible to eliminate the need that the parasitic element is short-circuited with the wireless-apparatus base.

(Fifth Embodiment)

It is feature of the fifth embodiment to load an inductor on a parasitic element.

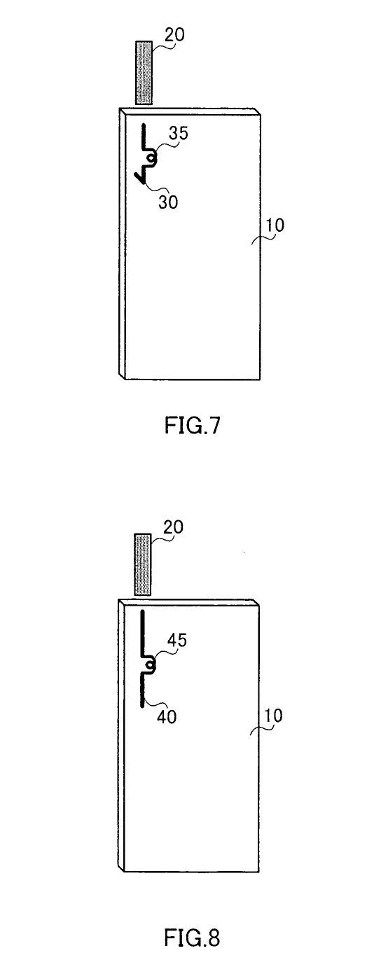

FIG. 7 is a view illustrating a configuration of an antenna for a cellular wireless apparatus according to the fifth embodiment of the present invention. In FIG. 7 the same members as in the antenna for a cellular wireless apparatus in FIGS. 3A and 3B are assigned the same reference numerals to omit descriptions thereof.

The antenna for a cellular wireless apparatus shown in the figure is comprised of wireless-apparatus base 10, planar radiation element 20, parasitic element 30 and inductor 35.

Inductor 35 is loaded on parasitic element 30. Since loading inductor 35 results in a longer electrical length of parasitic element 30, it is possible to operate the parasitic element with a length longer than its physical length. In other words, it is possible to decrease a physical element length of a parasitic element and thus to miniaturize the apparatus.

When it is assumed herein to provide parasitic element 30 with a length for operating as a reflector, the directivity of the antenna for a cellular wireless apparatus is in the direction of from parasitic element 30 to planar radiation element 20. In this case, when the side of wireless-apparatus base 10 on which parasitic element 30 is disposed faces toward the body of a user using the cellular wireless apparatus, the antenna for the cellular wireless apparatus has the directivity in the direction opposite to the human body.

Meanwhile, when it is assumed herein to provide parasitic element 30 with a length for operating as a director, the directivity of the antenna for a cellular wireless apparatus is in the direction of from planar radiation element 20 to parasitic element 30. In this case, when the side of wireless-apparatus base 10 on which parasitic element 30 is not disposed faces toward the body of a user using the cellular wireless apparatus, the antenna for the cellular wireless apparatus has the directivity in the direction opposite to the human body.

Further, FIG. 8 illustrates a configuration where one end of a parasitic element is opened without being short-circuited with the wireless-apparatus side.

In FIG. 8, inductor 45 is loaded on parasitic element 40. Since loading inductor 45 results in a longer electrical length of parasitic element 40, it is possible to operate the parasitic element with a length longer than its actual length. Then, by setting the length of parasitic element 40 at a length for operating as a reflector or director as described above, the antenna for the cellular wireless apparatus has the directivity in the direction opposite to the human body.

As described above, in the antenna for a cellular wireless apparatus according to this embodiment, since an inductor is loaded on a parasitic element with a length for operating as a reflector or director, it is possible to decrease the length of a parasitic element while the antenna has the directivity in the direction opposite to the human body, and it is thereby possible for a small-size antenna to reduce effects caused by the human body and improve the antenna gain.

(Sixth Embodiment)

It is feature of the sixth embodiment to provide a plurality of radiation elements and parasitic elements respectively corresponding to the radiation elements.

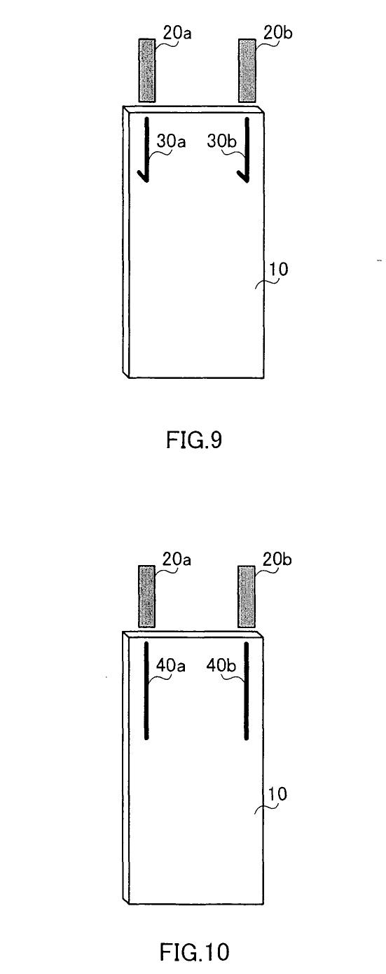

FIG. 9 is a view illustrating a configuration of an antenna for a cellular wireless apparatus according to the sixth embodiment of the present invention. In FIG. 9 the same members as in the antenna for a cellular wireless apparatus in FIGS. 3A and 3B are assigned the same reference numerals to omit descriptions thereof.

The antenna for a cellular wireless apparatus shown in the figure is comprised of wireless-apparatus base 10, planar radiation elements 20a and 20b, and parasitic elements 30a and 30b.

Planar radiation element 20a is disposed adjacent to parasitic element 30a to pair, while planar radiation element 20b is disposed adjacent to parasitic element 30b to pair. Radiation elements 20a and 20b are spaced a predetermined length apart, while parasitic elements 30a and 30b are spaced a predetermined length apart. Such a configuration achieves a diversity antenna in which different fading is observed in planar radiation elements 20a and 20b when radio signals are transmitted and received.

Further, by setting lengths of parasitic elements 30a and 30b at lengths for operating as reflectors or directors, the antenna for the cellular wireless apparatus has the directivity in the direction opposite to the human body.

Furthermore, as shown in FIG. 10, a configuration is available where respective opposite ends of parasitic elements 40a and 40b are opened and thus do not need to be short-circuited with wireless-apparatus base 10.

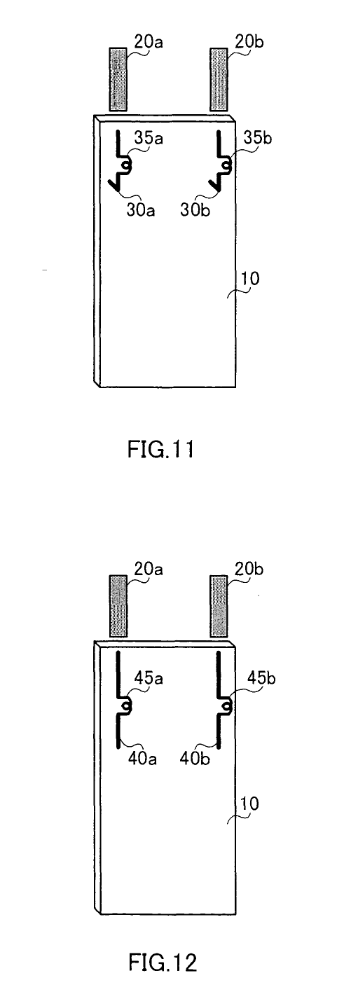

Moreover, as shown in FIGS. 11 and 12, inductors 35a, 35b, 40a and 40b are loaded respectively on parasitic elements 30a, 30b, 40a and 40b, whereby it is possible to decrease lengths of parasitic elements 30a, 30b, 40a and 40b.

In addition, while this embodiment explains the configuration with two radiation elements and two parasitic elements, the present invention is not limited to such a configuration, and is applicable to configurations with three or more radiation elements and parasitic elements.

As described above, the antenna for a cellular wireless apparatus according to this embodiment has two or more spaced radiation elements and a same number of spaced parasitic elements as the radiation elements with lengths for operating as reflectors or directors. Therefore, a diversity antenna is achieved with the directivity in the direction opposite to the human body, and it is thus possible to reduce effects caused by the human body and improve the antenna gain.

(Seventh Embodiment)

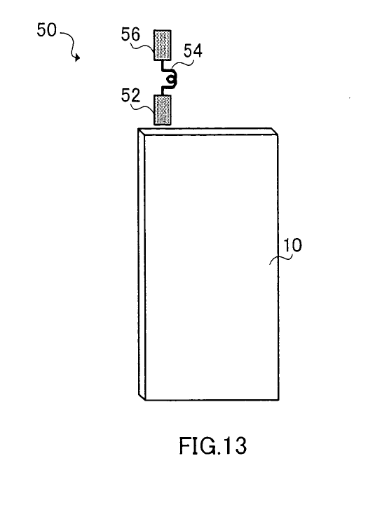

FIG. 13 is a view illustrating a configuration of an antenna for a cellular wireless apparatus according to the seventh embodiment of the present invention.

The antenna for a cellular wireless apparatus shown in the figure is comprised of wireless-apparatus base 10, radiator 50, first planar radiation element 52, inductor 54 and second planar radiation element 56.

Wireless-apparatus base 10 is a circuit board and feeds power to radiator 50. Radiator 50 is comprised of first planar radiation element 52, inductor 54 and second planar radiation element 56, resonates at a specific first frequency, and transmits and receives radio signals. First planar radiation element 52 resonates at a second frequency higher than the first frequency corresponding to its length, and transmits and receives radio signals. The impedance of inductor 54 becomes almost infinite at the second frequency at which first planar radiation element 52 resonates. Second planar radiation element 56 is coupled to first planar radiation element 52 via inductor 54 and corresponding to its length, specifies the first frequency at which radiator 50 resonates.

Next, the operation of the antenna for a cellular wireless apparatus having the above configurations will be described.

When transmitting and receiving radio signals of the first frequency at which radiator 50 resonates, since the impedance of inductor 54 is low, first planar radiation element 52, inductor 54 and second planar radiation element 56 entirely operate as a single radiator 50 to radiate and absorb radio waves.

When transmitting and receiving radio signals of the second frequency which is higher than the first frequency and at which first radiation element 52 resonates, since the impedance of inductor 54 is almost infinite, only first planar radiation element 52 operates as a radiator to radiate and absorb radio waves.

In addition, while this embodiment explains the configuration with two planar radiation elements, the present invention is not limited to such a configuration, and is applicable to configurations with three or more planar radiation elements coupled via inductors in the same way as described above.

As described above, in an antenna for a cellular wireless apparatus according to this embodiment, a plurality of planar radiation elements are coupled via an inductor such that its impedance is almost infinite at a frequency at which an entire portion of from the wireless-apparatus base to one end on the wireless-apparatus side of the inductor resonates, whereby it is possible to obtain a plurality of resonance frequencies and broaden the frequency band of the antenna for a cellular wireless apparatus.

(Eighth Embodiment)

It is a feature of the eighth embodiment that a plurality of parasitic elements is disposed corresponding to a radiator that resonates at a plurality of frequencies.

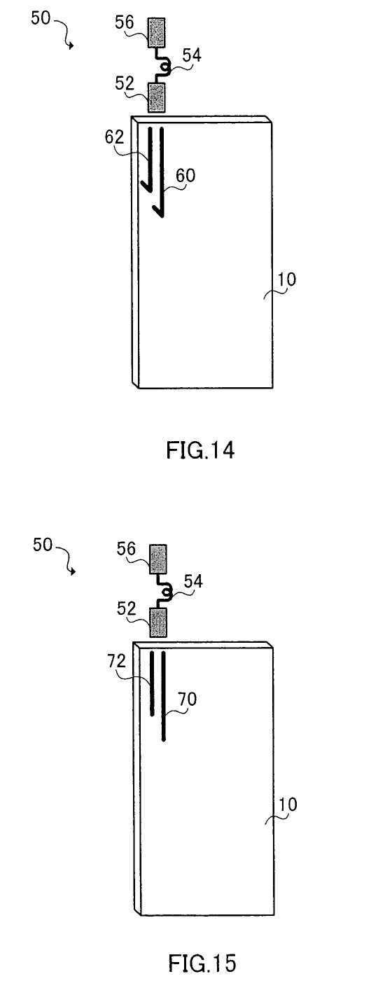

FIG. 14 is a view illustrating a configuration of an antenna for a cellular wireless apparatus according to the eighth embodiment of the present invention. In addition, in FIG. 14, the same members as in the antenna for a cellular wireless apparatus in FIG. 13 are assigned the same reference numerals to omit descriptions thereof.

The antenna for a cellular wireless apparatus shown in the figure is comprised of wireless-apparatus base 10, radiator 50, first planar radiation element 52, inductor 54, second planar radiation element 56 and first and second parasitic elements 60 and 62. In addition, since first parasitic element 60 is longer than second parasitic element 62, the resonance frequency of first parasitic element 60 is lower than the resonance frequency of parasitic element 62.

Parasitic element 60 is on its one end short-circuited with wireless-apparatus base 10, and in transmitting and receiving radio signals of the first frequency at which radiator 50, composed of first planar radiation element 52, inductor 54 and second planar radiation element 56, resonates, operates as a reflector or director corresponding to its length. Parasitic element 62 is on its one end short-circuited with wireless-apparatus base 10, and in transmitting and receiving radio signals of the second frequency which is higher than the first frequency and at which first planar radiation element 52 resonates, operates as a reflector or director corresponding to its length.

When it is assumed herein to provide parasitic elements 60 and 62 with lengths for operating as reflectors, the directivity of the antenna for a cellular wireless apparatus is in the direction of from parasitic elements 60 and 62 to radiator 50 at two frequencies at which first planar radiation element 52 or radiator 50 resonates. In this case, when the side of wireless-apparatus base 10 on which parasitic elements 60 and 62 are disposed faces toward the body of a user using the cellular wireless apparatus, the antenna for the cellular wireless apparatus has the directivity in the direction opposite to the human body.

Meanwhile, when it is assumed herein to provide parasitic elements 60 and 62 with lengths for operating as directors, the directivity of the antenna for a cellular wireless apparatus is in the direction of from radiator 50 to parasitic elements 60 and 62 at two frequencies at which first planar radiation element 52 or radiator 50 resonates. In this case, when the side of wireless-apparatus base 10 on which parasitic elements 60 and 62 are not disposed faces toward the body of a user using the cellular wireless apparatus, the antenna for the cellular wireless apparatus has the directivity in the direction opposite to the human body.

Further, FIG. 15 illustrates a configuration where one end of each parasitic element is opened without being short-circuited with the wireless-apparatus base.

In FIG. 15, parasitic element 70 operates as a reflector or director corresponding to its length, in transmitting and receiving radio signals of the first frequency at which radiator 50 resonates. Parasitic element 72, which is shorter than parasitic element 70, operates as a reflector or director corresponding to its length, in transmitting and receiving radio signals of the second frequency which is higher than the first frequency and at which first planar radiation element 52 resonates.

As described above, according to this embodiment, an antenna for a cellular wireless apparatus having a radiation element which resonates at a plurality of frequencies is provided with parasitic elements corresponding to the frequencies respectively, and thus has the directivity in the direction opposite to the human body. Therefore, it is possible to reduce effects caused by the human body and improve the antenna gain in an antenna for transmitting and receiving radio signals of a plurality of frequencies.

(Ninth Embodiment)

It is a feature of the ninth embodiment to dispose a parasitic element loaded with an inductor at midpoint corresponding to a radiator that resonates at a plurality of frequencies.

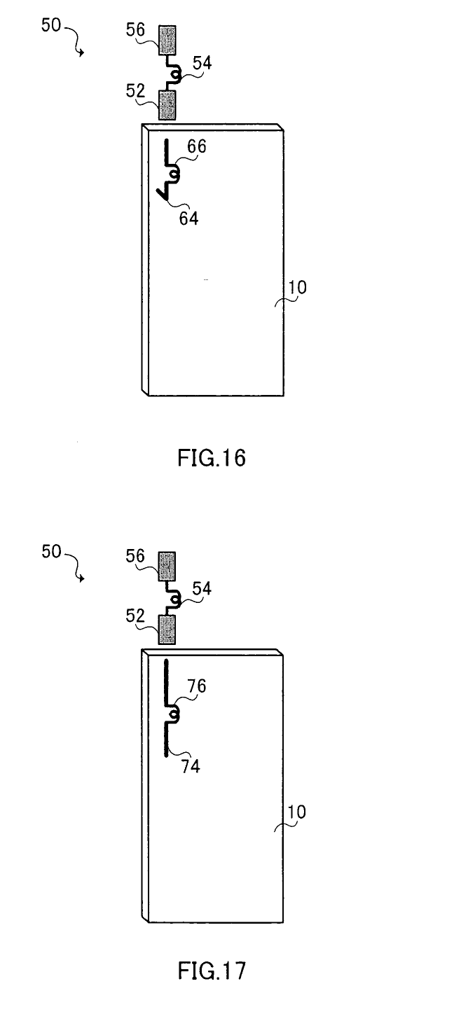

FIG. 16 is a view illustrating a configuration of an antenna for a cellular wireless apparatus according to the ninth embodiment of the present invention. In addition, in FIG. 16, the same members as in the antenna for a cellular wireless apparatus in FIG. 13 are assigned the same reference numerals to omit descriptions thereof.

The antenna for a cellular wireless apparatus shown in the figure is comprised of wireless-apparatus base 10, radiator 50, first planar radiation element 52, inductor 54, second planar radiation element 56, parasitic element 64 and inductor 66.

Inductor 66 is loaded on parasitic element 64. Inductor 66 has almost infinite impedance at the second frequency at which only first planar radiation element 50 operates as a radiation element. Therefore, at the first frequency at which radiator 50 resonates, parasitic element 64 entirely operates as a reflector or director. At the second frequency which is higher than the first frequency and at which only first planar radiation element 52 operates as a radiation element, only an upper portion or lower portion than inductor 66 of parasitic element 64 operates as a reflector or director. The length of parasitic element 64 and position of inductor 66 are specified by frequency of radio signals transmitted and received in the antenna for a cellular wireless apparatus. Accordingly, although it is not possible to vary the length of parasitic element 64 depending on using as a reflector or director, parasitic element 64, which has a length thereof and position of inductor 66 specified by frequency of radio signals to transmit and receive, operates as a reflector or director corresponding to the length.

When parasitic element 64 is herein assumed to have a length for operating as a reflector, the directivity of the antenna for a cellular wireless apparatus is in the direction of from parasitic element 64 to radiator 50. In this case, when the side of wireless-apparatus base 10 on which parasitic element 64 is disposed faces toward the body of a user using the cellular wireless apparatus, the antenna for the cellular wireless apparatus has the directivity in the direction opposite to the human body.

Meanwhile, when parasitic element 64 is assumed to have a length for operating as a director, the directivity of the antenna for a cellular wireless apparatus is in the direction of from radiator 50 to parasitic element 64. In this case, when the side of wireless-apparatus base 10 on which parasitic element 64 is not disposed faces toward the body of a user using the cellular wireless apparatus, the antenna for the cellular wireless apparatus has the directivity in the direction opposite to the human body.

Further, FIG. 17 illustrates a configuration where one end of a parasitic element is opened without being short-circuited with the wireless-apparatus base.

In FIG. 17, inductor 76 is loaded on parasitic element 74. Since inductor 76 is loaded, parasitic element 74 varies its electrical length with frequency, and corresponding to the length, operates as a reflector or director for a plurality of frequencies.

As described above, in the antenna for a cellular wireless apparatus according to this embodiment, since an inductor is loaded on a parasitic element with a length for operating as a reflector or director, the antenna has the directivity in the direction opposite to the human body, and it is thereby possible to reduce effects caused by the human body and improve the antenna gain in a small-size antenna for a plurality of frequencies.

(Tenth Embodiment)

It is a feature of the tenth embodiment that parasitic elements are disposed respectively corresponding to a plurality of radiators that resonates at a plurality of frequencies.

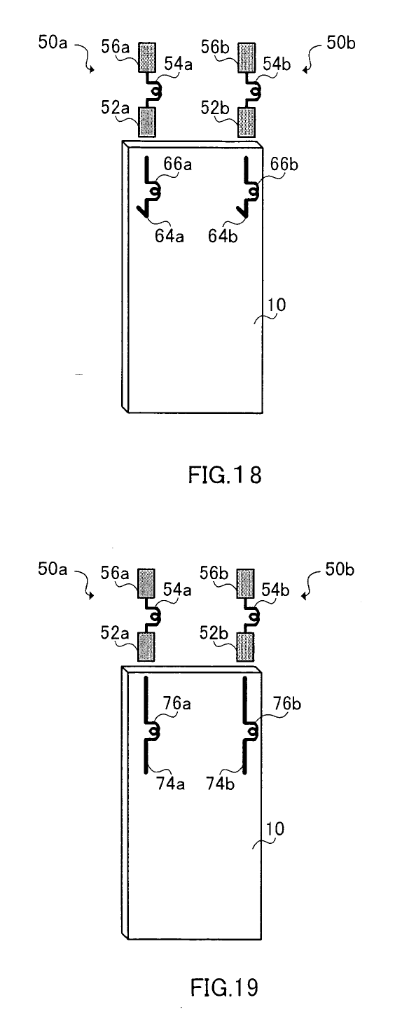

FIG. 18 is a view illustrating a configuration of an antenna for a cellular wireless apparatus according to the tenth embodiment of the present invention. In FIG. 18, the same members as in the antenna for a cellular wireless apparatus in FIG. 13 are assigned the same reference numerals to omit descriptions thereof.

The antenna for a cellular wireless apparatus shown in the figure is comprised of wireless-apparatus base 10, radiators 50a and 50b, first planar radiation elements 52a and 52b, inductors 54a and 54b, second planar radiation elements 56a and 56b, parasitic elements 64a and 64b, and inductors 66a and 66b.

Radiator 50a is composed of first planar radiation element 52a, inductor 54a and second planar radiation element 56a, and is disposed adjacent to parasitic element 64a to pair, while radiator 50b is composed of first planar radiation element 52b, inductor 54b and second planar radiation element 56b, and is disposed adjacent to parasitic element 64b to pair. Radiators 50a and 50b are spaced a predetermined length apart, while parasitic elements 64a and 64b are spaced a predetermined length apart. Such a configuration achieves a diversity antenna in which different fading is observed in radiators 50a and 50b when radio signals are transmitted and received.

Further, by setting lengths of parasitic elements 64a and 64b at lengths for operating as reflectors or directors, the antenna for the cellular wireless apparatus has the directivity in the direction opposite to the human body. Parasitic elements 64a and 64b are loaded respectively with inductors 66a and 66b, and, therefore, operate as directors or reflectors for two frequencies.

Moreover, as shown in FIG. 19, a configuration is available where respective opposite ends of parasitic elements 74a and 74b are opened and thus do not need to be short-circuited with wireless-apparatus base 10.

In addition, while this embodiment explains the configuration with two radiators and two parasitic elements, the present invention is not limited to such a configuration, and is applicable to configurations with three or more radiators and parasitic elements.

As described above, the antenna for a cellular wireless apparatus according to this embodiment has two or more spaced radiators that resonate at a plurality of frequencies and a same number of spaced parasitic elements as the radiation elements with lengths for operating as reflectors or directors. It is thus possible to achieve a diversity antenna capable of transmitting and receiving radio signals of a plurality of frequencies, while having the directivity in the direction opposite to the human body, and therefore, it is possible to reduce effects caused by the human body and improve the antenna gain in an antenna resistant to multipath fading.

(Eleventh Embodiment)

It is a feature of the eleventh embodiment that a radiation element and parasitic element are printed on a wireless-apparatus base.

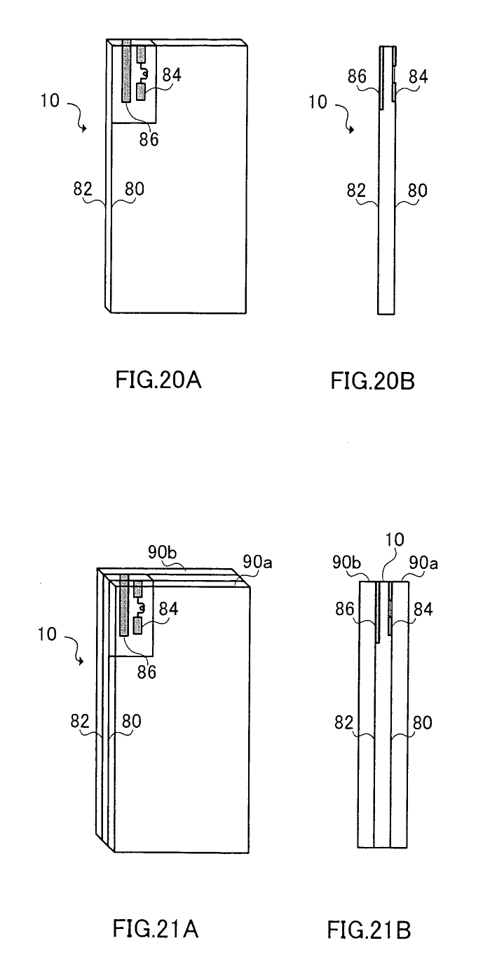

FIGS. 20A and 20b are respectively a schematic perspective view and side view each illustrating a configuration of an antenna for a cellular wireless apparatus according to the eleventh embodiment of the present invention.

The antenna for a cellular wireless apparatus shown in the figures is comprised of wireless-apparatus base 10, planar radiation element 84 and planar parasitic element 86.

Planar radiation element 84 is printed on one side 80 of wireless-apparatus base 10. Planar parasitic element 86 is printed on the other side 82 of wireless-apparatus base 10. Planar parasitic element 86 operates as a reflector or director corresponding to its length. Such a configuration enables a thin antenna for a cellular wireless apparatus.

When planar parasitic element 86 has a length for operating as a reflector, the directivity of the antenna for a cellular wireless apparatus is in the direction of from planar parasitic element 86 to planar radiation element 84. In this case, when the side of wireless-apparatus base 10 on which planar parasitic element 86 is disposed faces toward the body of a user using the cellular wireless apparatus, the antenna for the cellular wireless apparatus has the directivity in the direction opposite to the human body.

Meanwhile, when planar parasitic element 86 has a length for operating as a director, the directivity of the antenna for a cellular wireless apparatus is in the direction of from planar radiation element 84 to planar parasitic element 86. In this case, when the side of wireless-apparatus base 10 on which planar parasitic element 86 is not disposed faces toward the body of a user using the cellular wireless apparatus, the antenna for the cellular wireless apparatus has the directivity in the direction opposite to the human body.

Further, as shown in FIGS. 21A and 21B, a configuration is available where wireless-apparatus base 10 is sandwiched between dielectric members 90a and 90b.

Such a configuration generates the dielectric effect, decreases physical lengths of planar radiation element 84 and planar parasitic element 86, and thus enables a further miniaturized antenna for a cellular wireless apparatus.

As described above, in the antenna for a cellular wireless apparatus according to this embodiment, a planar radiation element is printed on one side of a wireless-apparatus base, while a planar parasitic element is printed on the other side of the base, thereby resulting in the directivity in the direction opposite to the human body, and it is thus possible for a thinner and small-size antenna to reduce effects caused by the human body and improve the antenna gain.

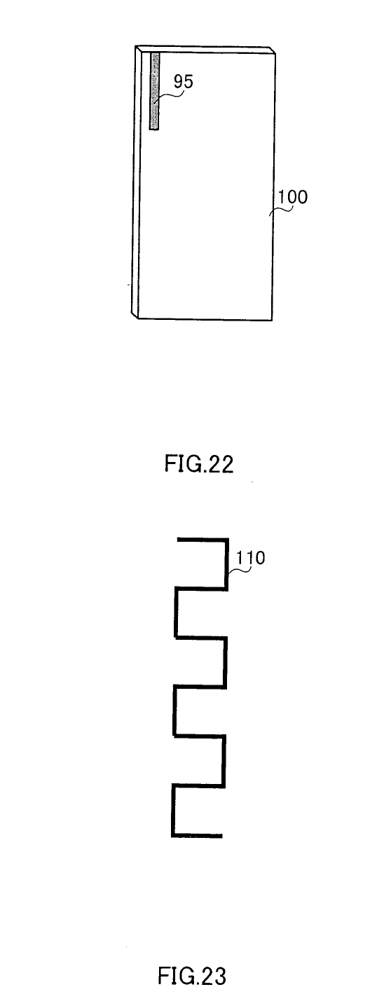

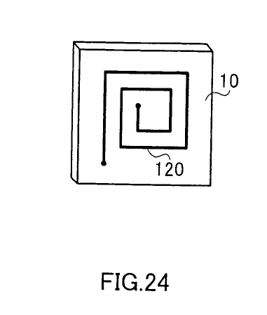

In addition, in each of the above-mentioned embodiments, as shown in FIG. 22, it is possible to fix parasitic element 95 to an inner surface of housing 100, for example, using deposition or bonding. Further, it is possible to miniaturize a radiation element and parasitic element by forming a radiation element and/or parasitic element 110 into the shape of meander as shown in FIG. 23 or zigzag, or printing on wireless-apparatus base 10 inductor 120 to be loaded on a radiation element and parasitic element in a pattern as shown in FIG. 24.

As described above, according to the present invention, it is possible to provide the directivity in the direction opposite to the human body and improve the gain.

This application is based on the Japanese Patent Application No.2001-225197 filed on Jul. 25, 2001, entire content of which is expressly incorporated by reference herein.

### INDUSTRIAL APPLICABILITY

The present invention is applicable to an antenna for a cellular wireless apparatus used in the cellular wireless apparatus such as a cellular telephone.

1. An antenna for a cellular wireless apparatus, comprising:
a base of the wireless apparatus;
a radiation element to which power is fed from the base of the wireless apparatus; and
a parasitic element that is disposed adjacent to the radiation element and has an electrical length for operating as a reflector or director.

2. The antenna for a cellular wireless apparatus according to claim 1, wherein the parasitic element is on its one end short-circuited with the base.

3. The antenna for a cellular wireless apparatus according to claim 1, wherein the parasitic element is opened on its opposite ends.

4. The antenna for a cellular wireless apparatus according to claim 1, wherein an inductive element to electrically extend a length of the parasitic element is loaded at midpoint of the parasitic element.

5. The antenna for a cellular wireless apparatus according to claim 1, wherein two or more radiation elements and a same number of parasitic elements as the radiation elements are disposed and radio signals are transmitted and received in space diversity.

6. The antenna for a cellular wireless apparatus according to claim 1, wherein the radiation element is comprised of a plurality of radiation element members coupled in series via an inductive element that is disposed between adjacent radiation element members, and in transmitting and receiving radio signals of frequency at which a portion of the radiation element on a power-feeder side of the inductive element resonates, the radiation element members that sandwich the inductive element are electrically interrupted.

7. The antenna for a cellular wireless apparatus according to claim 6, wherein the parasitic element is on its one end short-circuited with the base.

8. The antenna for a cellular wireless apparatus according to claim 6, wherein the parasitic element is opened on its opposite ends.

9. The antenna for a cellular wireless apparatus according to claim 6, wherein an inductive element to electrically extend a length of the parasitic element is loaded at midpoint of the parasitic element.

10. The antenna for a cellular wireless apparatus according to claim 6, wherein two or more radiation elements and a same number of parasitic elements as the radiation elements are disposed and radio signals are transmitted and received in space diversity.

11. The antenna for a cellular wireless apparatus according to claim 1, wherein at least one of the radiation element and the parasitic element is fixed to the base.

12. The antenna for a cellular wireless apparatus according to claim 6, wherein at least one of the radiation element and the parasitic element is fixed to the base.

13. The antenna for a cellular wireless apparatus according to claim 11, wherein the base is covered on its both sides by dielectric members.

14. The antenna for a cellular wireless apparatus according to claim 12, wherein the base is covered on its both sides by dielectric members.

15. The antenna for a cellular wireless apparatus according to claim 1, wherein the parasitic element is fixed to an inner surface of a housing of the cellular wireless apparatus.

16. The antenna for a cellular wireless apparatus according to claim 6, wherein the parasitic element is fixed to an inner surface of a housing of the cellular wireless apparatus.

17. The antenna for a cellular wireless apparatus according to claim 1, wherein at least one of the radiation element and the parasitic element is in the form of a meander or of a zigzag.

18. The antenna for a cellular wireless apparatus according to claim 6, wherein at least one of the radiation element and the parasitic element is in the form of a meander or of a zigzag.

19. A communication terminal apparatus having the antenna for a cellular wireless apparatus according to claim 1.

20. A communication terminal apparatus having the antenna for a cellular wireless apparatus according to claim 6.

21. A base station apparatus that performs radio communications with the communication terminal apparatus according to claim 19.

22. A base station apparatus that performs radio communications with the communication terminal apparatus according to claim 20.
